(19) United States
(12) Patent Application Publication
(10) Pub. No.: US 2026/0279849 A1
(43) Pub. Date: Sep. 17, 2026

(54) FUEL CELL STACK

(71) Applicant: HONDA MOTOR CO., LTD., TOKYO (JP)

(72) Inventors: Naoki TANAKA, WAKO-SHI (JP); Kazuo NUNOKAWA, WAKO-SHI (JP); Yu YAMAGUCHI, WAKO-SHI (JP)

(21) Appl. No.: 19/563,245

(22) Filed: Mar. 11, 2026

(30) Foreign Application Priority Data
Mar. 13, 2025 (JP) 2025-040266

(51) Int. Cl. H01M 8/0273; H01M 8/0284; H01M 8/248; H01M 8/2483

(52) U.S. Cl. CPC H01M 8/0273; H01M 8/0284; H01M 8/248; H01M 8/2483

(57) ABSTRACT

Each of end structures of a fuel cell stack has an insulation member and a support member. Accommodation grooves are formed in the support member or the insulation member, and elastic seal members are accommodated in the accommodation grooves. The support member and the insulation member have a plurality of flow passages through which the fuel gas, the oxygen-containing gas, or the coolant flows. The elastic seal members surround the plurality of flow passages. Three or more connecting bolts are arranged around each of the plurality of flow passages.

### CROSS-REFERENCE TO RELATED APPLICATIONS

This application is based upon and claims the benefit of priority from Japanese Patent Application No. 2025-040266 filed on Mar. 13, 2025, the contents of which are incorporated herein by reference.

### BACKGROUND OF THE INVENTION

### Field of the Invention

The present disclosure relates to a fuel cell stack.

### Description of the Related Art

A fuel cell stack includes a cell stack body in which unit cells are stacked, and end structures provided at opposite ends of the cell stack body. Each of the end structures includes an end plate disposed at the outermost position in the stacking direction of the cell stack body, an insulation member arranged between the cell stack body and the end plate, a terminal plate interposed between the cell stack body and the insulation member, and the like.

Seals for preventing leakage of reactant gases and a coolant may be provided between two of the plurality of components that are in contact with each other. An example of the material of the seals is a liquid gasket (FIPG; Formed In Place Gasket) described in JP 2017-062891 A. As is well known, liquid gaskets exhibit sealing performance upon curing.

### SUMMARY OF THE INVENTION

When a liquid gasket is used, there is a concern that the sealing performance may decrease with the passage of time. In order to eliminate this concern, it is conceivable to use an elastic seal member (elastic solid) such as an O-ring. However, in this case, the following inconveniences are expected.

That is, the elastic seal member is compressed when the fuel cell stack is clamped to be assembled. The compressed elastic seal member exhibits an elastic restoring force to return to its original shape. The elastic restoring force acts as a reaction force on the two members sandwiching the elastic seal member therebetween. In case where a gap is formed between the two members due to the reaction force of the elastic seal member, the sealing performance between the two members is reduced.

An object of the present invention is to solve the aforementioned problem.

An aspect of the present disclosure is characterized by a fuel cell stack including a cell stack body in which a plurality of unit cells are stacked, and end structures provided at opposite ends of the cell stack body in a stacking direction, wherein each of the end structures includes: an end plate disposed at an outermost position in the stacking direction; an insulation member arranged between the cell stack body and the end plate in the stacking direction; a support member interposed between the cell stack body and the insulation member in the stacking direction; an accommodation groove formed in the support member or the insulation member; an elastic seal member accommodated in the accommodation groove and configured to seal between the support member and the insulation member; and a plurality of connection bolts configured to connect the support member and the insulation member, the support member includes a plurality of flow passages each extending along the stacking direction and allowing a fuel gas, an oxygen-containing gas, or a coolant provided for the cell stack body to flow therethrough, the elastic seal member surrounds outer peripheries of the plurality of flow passages, and three or more of the plurality of connection bolts are arranged around each of the plurality of flow passages.

According to the present disclosure, a gap is prevented from being formed between the support member and the insulation member due to the compressed elastic seal member returning to its original shape, thereby avoiding a decrease in the sealing performance between the support member and the insulation member.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic perspective view of an entire fuel cell stack according to an embodiment of the present invention;

FIG. 2 is a partial, exploded, perspective view of an end structure;

FIG. 3 is a schematic front view of a part of the end structure as viewed from the inside in the stacking direction, with the support member omitted;

FIG. 4 is a schematic front view of another part of the end structure as viewed from the inside in the stacking direction, with the support member omitted;

FIG. 5 is a cross-sectional view taken along line V-V in FIG. 3;

FIG. 6 is a side sectional view of a main part of the end structure as viewed from the widthwise direction; and

FIGS. 7A and 7B are cross-sectional views of an elastic seal member taken along a direction perpendicular to the longitudinal direction.

### DETAILED DESCRIPTION OF THE INVENTION

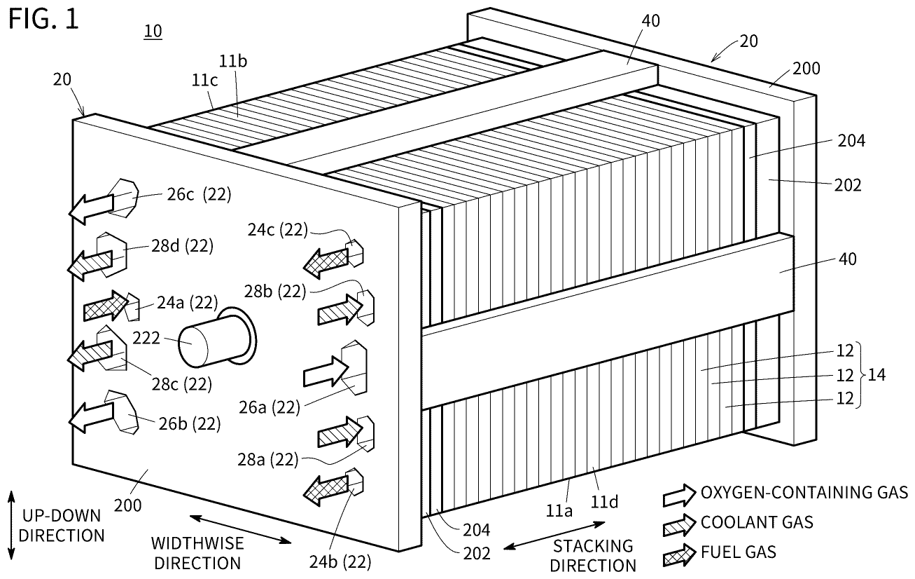

In the following description, a direction in which unit cells 12 shown in FIG. 1 are stacked is the “stacking direction”, and refers to a longitudinal direction of a cell stack body 14 (an axial direction of a fuel cell stack 10). A direction that is perpendicular to the stacking direction and connects a first side 11a and a second side 11b of the fuel cell stack 10 is the “up-down direction”. A direction that is perpendicular to the stacking direction and the up-down direction and connects a third side 11c and a fourth side 11d of the fuel cell stack 10 is the “widthwise direction”. However, the up-down direction and the widthwise direction are provided for the sake of convenience in order to simplify the description and facilitate understanding, and are not necessarily the directions when the fuel cell stack 10 is actually used.

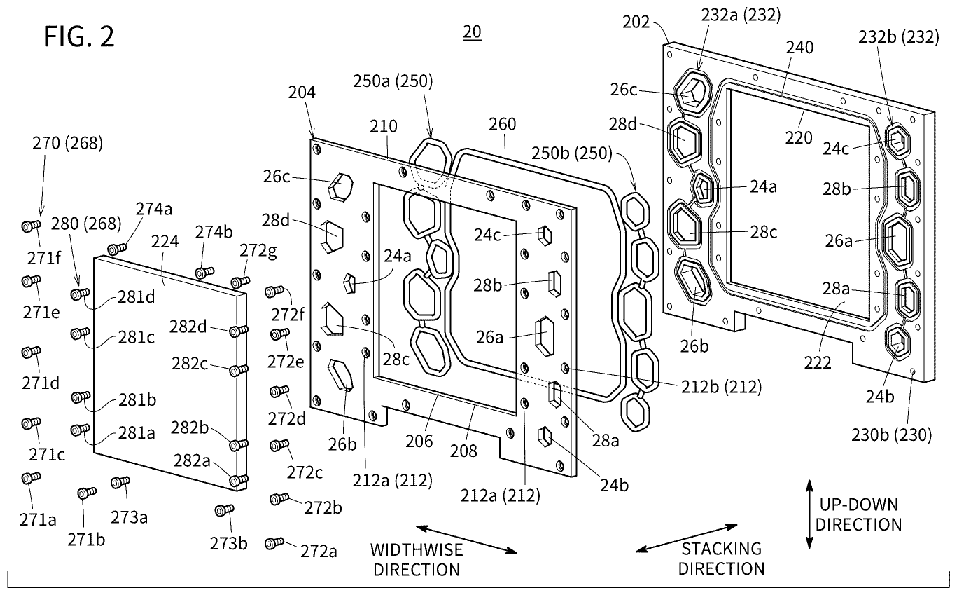

The “thickness” of anelastic seal members 250 and the like shown in FIGS. 2 to 4 refers to the thickness in an uncompressed state. The “uncompressed state” means a state in which no external force such as a compression force is applied to the elastic seal members 250 or the elastic gasket 260.

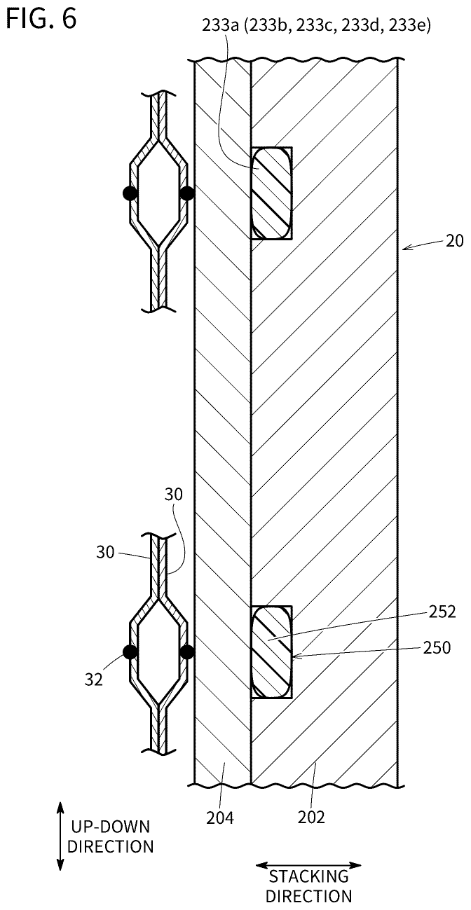

FIG. 1 is a schematic perspective view of an entire fuel cell stack 10 according to the present embodiment. The fuel cell stack 10 includes the cell stack body 14 in which a plurality of unit cells 12 are stacked. In general, the unit cell 12 includes a membrane electrode assembly (MEA). The MEA includes an electrolyte membrane, and an anode and a cathode formed respectively on both end surfaces of the electrolyte membrane. The unit cell 12 is formed by sandwiching the MEA between a pair of separators 30 (see FIG. 6). Such a configuration of the unit cell 12 in the fuel cell stack 10 is well known, and therefore, illustration and detailed description thereof are omitted.

The fuel cell stack 10 includes a pair of end structures 20 provided at opposite ends thereof in the stacking direction. The pair of end structures 20 include a pair of end plates 200 disposed at the outermost positions in the stacking direction.

The cell stack body 14 includes a plurality of flow passages 22. Each of the plurality of flow passages 22 is open at one of the pair of end plates 200. In the illustrated example, the plurality of flow passages 22 include a fuel gas supply passage 24a, an oxygen-containing gas supply passage 26a, a first coolant supply passage 28a, and a second coolant supply passage 28b. Further, the flow passages 22 include a first fuel gas discharge passage 24b, a second fuel gas discharge passage 24c, a first oxygen-containing gas discharge passage 26b, a second oxygen-containing gas discharge passage 26c, a first coolant discharge passage 28c, and a second coolant discharge passage 28d. The plurality of flow passages 22 may include only one coolant supply passage. The plurality of flow passages 22 may include only one fuel gas discharge passage, only one oxygen-containing gas discharge passage, or only one coolant discharge passage.

In the illustrated example, at one end of the fuel cell stack 10 in the widthwise direction (the third side 11c), the first oxygen-containing gas discharge passage 26b, the first coolant discharge passage 28c, the fuel gas supply passage 24a, the second coolant discharge passage 28d, and the second oxygen-containing gas discharge passage 26c are arranged from the lower side to the upper side. At the other end of the fuel cell stack 10 in the widthwise direction (fourth side 11d), the first fuel gas discharge passage 24b, the first coolant supply passage 28a, the oxygen-containing gas supply passage 26a, the second coolant supply passage 28b, and the second fuel gas discharge passage 24c are arranged from the lower side to the upper side. However, the above arrangement order is an example.

The plurality of flow passages 22 extend along the stacking direction. In the fuel cell stack 10, the reactant gases (oxygen-containing gas and fuel gas) and the coolant flow along the stacking direction and are distributed to each of the plurality of unit cells 12 via an oxygen-containing gas flow field, a fuel gas flow field, and a coolant flow field (not shown) formed by the pair of separators 30.

In the present embodiment, each of the pair of end structures 20 includes an insulation member 202 and a support member 204. The insulation member 202 is placed between the cell stack body 14 and the end plate 200. The support member 204 is interposed between the cell stack body 14 and the insulation member 202. The insulation member 202 is placed outward of the support member 204 in the stacking direction and abuts against the support member 204.

The insulation member 202 and the support member 204 have the plurality of flow passages 22, as in the cell stack body 14. That is, the insulation member 202 and the support member 204 have the fuel gas supply passage 24a, the oxygen-containing gas supply passage 26a, the first coolant supply passage 28a, the second coolant supply passage 28b, the first fuel gas discharge passage 24b, the second fuel gas discharge passage 24c, the first oxygen-containing gas discharge passage 26b, the second oxygen-containing gas discharge passage 26c, the first coolant discharge passage 28c, and the second coolant discharge passage 28d. However, in the insulation member 202, the fuel gas supply passage 24a, the oxygen-containing gas supply passage 26a, the first fuel gas discharge passage 24b, the second fuel gas discharge passage 24c, the first oxygen-containing gas discharge passage 26b, and the second oxygen-containing gas discharge passage 26c may be closed.

In the embodiment shown in FIG. 2, the support member 204 has an opening 206 that extends through the support member 204 along the stacking direction. Therefore, the support member 204 is a rectangular (closed-loop) member. The material of the support member 204 is, for example, stainless steel.

The support member 204 has an inner edge portion 208 around the opening 206 and an outer edge portion 210 along the first side 11a to the fourth side 11d. A plurality of bolt insertion holes 212 are formed in the inner edge portion 208 and the outer edge portion 210, respectively. Hereinafter, the plurality of bolt insertion holes 212 formed in the inner edge portion 208 may be referred to as inner insertion holes 212a, and the plurality of bolt insertion holes 212 formed in the outer edge portion 210 may be referred to as outer insertion holes 212b.

A current collecting member 224 made of a conductor is inserted into the opening 206. The current collecting member 224 overlaps the MEA of the outermost unit cell 12 in the stacking direction. The current collecting member 224 and the support member 204 are electrically insulated from each other. Therefore, no current flows from the current collecting member 224 to the support member 204, and no current flows from the support member 204 to the current collecting member 224.

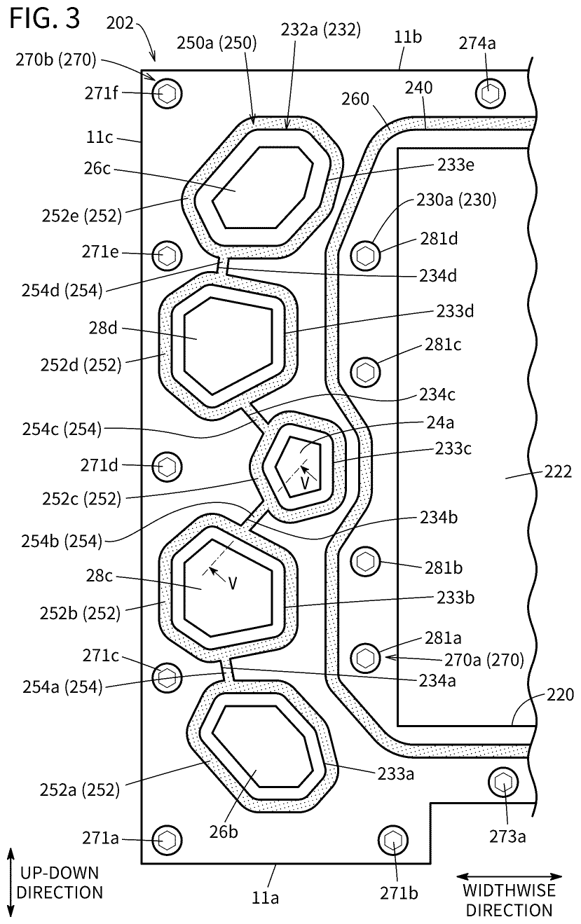

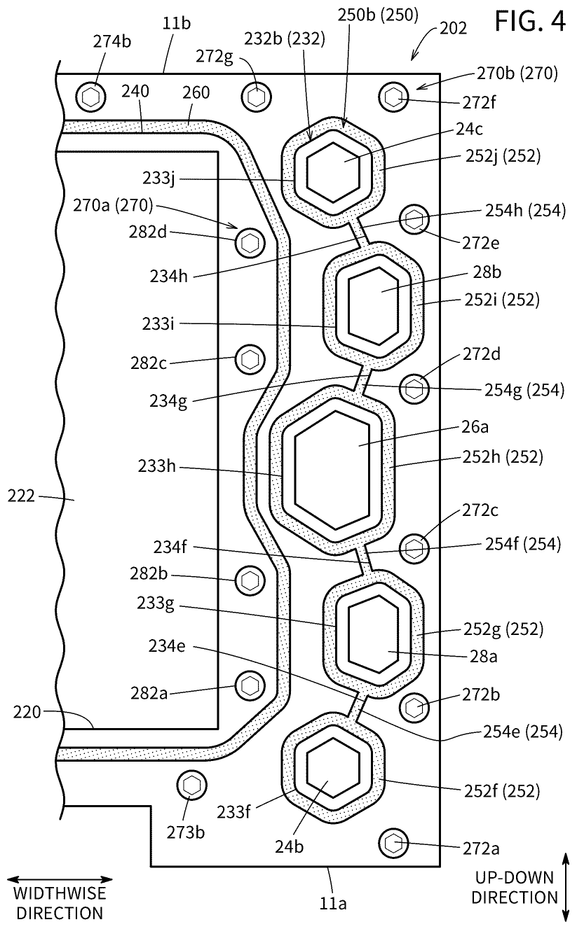

As shown in FIGS. 3 and 4, the insulation member 202 has an engagement opening 220. Therefore, the insulation member 202 is a rectangular (closed-loop) member. The terminal plate 222 is held at the engagement opening 220. The terminal plate 222 is electrically connected to the current collecting member 224. The electric power obtained in the cell stack body 14 is supplied to an external load via the current collecting member 224 and the terminal plate 222.

In the illustrated embodiment, the support member 204, the current collecting member 224, and the terminal plate 222 are separate members. However, the support member 204, the current collecting member 224, and the terminal plate 222 may be integrated to form a terminal member. In this case, the support member 204 (terminal member) does not need to have the opening 206. Further, the insulation member 202 does not need to have the engagement opening 220.

A preferable specific example of the material of the insulation member 202 is resin. In this case, the insulation member 202 is produced by, for example, injection molding using a molten resin as a raw material. This makes it possible to mass-produce the insulation member 202, in which a plurality of bolt holes 230, accommodation grooves 232, and the like, which will be described later, are formed, easily at low cost. However, the material of the insulation member 202 is not limited to resin.

The insulation member 202 has a plurality of bolt holes 230. The positions of the plurality of bolt holes 230 correspond to the positions of the plurality of bolt insertion holes 212, respectively. Hereinafter, the bolt holes 230 corresponding to the inner insertion holes 212a are referred to as inner holes 230a. The inner holes 230a are located inward of a surrounding groove 240 (described later) in the widthwise direction. The bolt holes 230 corresponding to the outer insertion holes 212b are referred to as outer holes 230b. The outer holes 230b are located outward of the surrounding groove 240 in the widthwise direction or the up-down direction.

The end structure 20 includes accommodation grooves 232 and elastic seal members 250. The accommodation grooves 232 are formed in an end surface of the insulation member 202 facing the support member 204. The accommodation grooves 232 may be formed in an end surface of the support member 204 facing the insulation member 202.

The accommodation grooves 232 include a first groove 232a and a second groove 232b. As shown in FIG. 3, the first groove 232a includes a first annular groove portion 233a, a second annular groove portion 233b, a third annular groove portion 233c, a fourth annular groove portion 233d, and a fifth annular groove portion 233e. The first annular groove portion 233a surrounds the first oxygen-containing gas discharge passage 26b, and the second annular groove portion 233b surrounds the first coolant discharge passage 28c. The third annular groove portion 233c, the fourth annular groove portion 233d, and the fifth annular groove portion 233e surround the fuel gas supply passage 24a, the second coolant discharge passage 28d, and the second oxygen-containing gas discharge passage 26c, respectively.

The first groove 232a further includes a first straight groove portion 234a, a second straight groove portion 234b, a third straight groove portion 234c, and a fourth straight groove portion 234d. The first straight groove portion 234a connects the first annular groove portion 233a and the second annular groove portion 233b. The second straight groove portion 234b connects the second annular groove portion 233b and the third annular groove portion 233c, and the third straight groove portion 234c connects the third annular groove portion 233c and the fourth annular groove portion 233d. The fourth straight groove portion 234d connects the fourth annular groove portion 233d and the fifth annular groove portion 233e.

As shown in FIG. 4, the second groove 232b includes a sixth annular groove portion 233f, a seventh annular groove portion 233g, an eighth annular groove portion 233h, a ninth annular groove portion 233i, and a tenth annular groove portion 233j. The sixth annular groove portion 233f surrounds the first fuel gas discharge passage 24b, and the seventh annular groove portion 233g surrounds the first coolant supply passage 28a. The eighth annular groove portion 233h, the ninth annular groove portion 233i, and the tenth annular groove portion 233j surround the oxygen-containing gas supply passage 26a, the second coolant supply passage 28b, and the second fuel gas discharge passage 24c, respectively.

The second groove 232b further includes a fifth straight groove portion 234e, a sixth straight groove portion 234f, a seventh straight groove portion 234g, and an eighth straight groove portion 234h. The fifth straight groove portion 234e connects the sixth annular groove portion 233f and the seventh annular groove portion 233g. The sixth straight groove portion 234f connects the seventh annular groove portion 233g and the eighth annular groove portion 233h, and the seventh straight groove portion 234g connects the eighth annular groove portion 233h and the ninth annular groove portion 233i. The eighth straight groove portion 234h connects the ninth annular groove portion 233i and the tenth annular groove portion 233j.

On the other hand, the elastic seal members 250 includes a first seal body 250a (see FIGS. 2 and 3) and a second seal body 250b (see FIGS. 2 and 4). The first seal body 250a is accommodated in the first groove 232a, and the second seal body 250b is accommodated in the second groove 232b.

As shown in FIG. 3, the first seal body 250a includes a plurality of annular portions 252 and a plurality of connecting portions 254. The plurality of annular portions 252 include a first annular portion 252a, a second annular portion 252b, a third annular portion 252c, a fourth annular portion 252d, and a fifth annular portion 252e. The plurality of connecting portions 254 include a first connecting portion 254a, a second connecting portion 254b, a third connecting portion 254c, and a fourth connecting portion 254d. The first connecting portion 254a connects the first annular portion 252a and the second annular portion 252b. The second connecting portion 254b connects the second annular portion 252b and the third annular portion 252c, and the third connecting portion 254c connects the third annular portion 252c and the fourth annular portion 252d. The fourth connecting portion 254d connects the fourth annular portion 252d and the fifth annular portion 252e.

The first annular portion 252a to the fifth annular portion 252e are respectively accommodated in the first annular groove portion 233a to the fifth annular groove portion 233e. The first connecting portion 254a to the fourth connecting portion 254d are respectively accommodated in the first straight groove portion 234a to the fourth straight groove portion 234d.

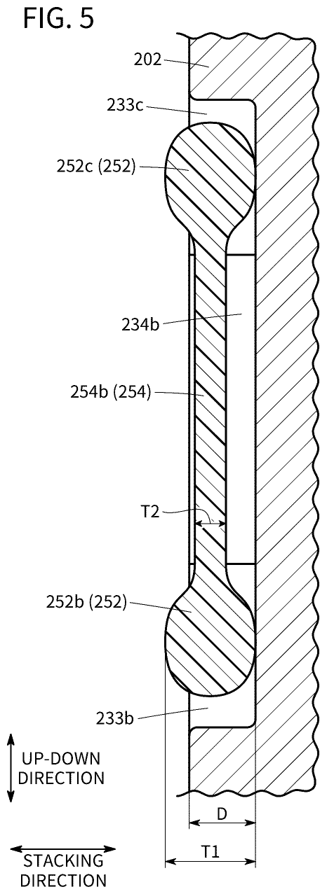

FIG. 5 is a cross-sectional view taken along line V-V in FIG. 3. As understood from FIG. 5, the depth direction of the first groove 232a and the second groove 232b (the plurality of accommodation grooves 232) coincides with the stacking direction. The thickness T2 of the second connecting portion 254b along the stacking direction is smaller than the thickness T1 of the second annular portion 252b and the thickness T1 of the third annular portion 252c along the stacking direction. The thickness T1 of the plurality of annular portions 252 is substantially equal to each other. Similarly, the thicknesses T2 of the plurality of connecting portions 254 are also substantially equal to each other. The depth D of the first groove 232a is substantially constant.

The thickness T1 of the second annular portion 252b and the third annular portion 252c is slightly larger than the depth D of the second annular groove portion 233b and the third annular groove portion 233c. Therefore, before the insulation member 202 and the support member 204 abut against each other, the second annular portion 252b in the second annular groove portion 233b and the third annular portion 252c in the third annular groove portion 233c slightly protrude from the surface of the insulation member 202. The same applies to the first annular portion 252a, the fourth annular portion 252d, and the fifth annular portion 252e.

In contrast, the thickness T2 of the second connecting portion 254b is slightly smaller than the depth D of the second straight groove portion 234b. Therefore, before the insulation member 202 and the support member 204 come into contact with each other, the entire second connecting portion 254b is accommodated in the second straight groove portion 234b. The same applies to the first connecting portion 254a, the third connecting portion 254c, and the fourth connecting portion 254d. Alternatively, before the insulation member 202 and the support member 204 abut against each other, a part of the plurality of connecting portions 254 may be protruded from the first groove 232a. Alternatively, the position of the end of each of the plurality of connection portions 254 in the stacking direction may be the same as the position of the end surface of the insulation member 202.

FIG. 6 is a side sectional view of a main part of the end structure 20 as viewed from the widthwise direction. As shown in FIG. 6, the first annular portion 252a to the fifth annular portion 252e preferably overlap bead seals 32 of the separators 30 in the stacking direction.

The above relationship is also the same for the second groove 232b and the second seal body 250b.

In the embodiment shown in FIGS. 2 to 4, each of the end structures 20 further includes the surrounding groove 240 formed in the insulation member 202. The surrounding groove 240 is located between the two accommodation grooves 232 (the first groove 232a and the second groove 232b) and surrounds the engaging opening 220. The depth direction of the surrounding groove 240 coincides with the stacking direction. If the engagement opening 220 is not formed in the insulation member 202, the surrounding groove 240 does not need to be formed in the insulation member 202. The surrounding groove 240 may be formed in the support member 204.

Each of the end structures 20 further comprises a closed-loop elastic gasket 260 accommodated in the surrounding groove 240. The elastic gasket 260 seals the outer periphery of the engagement opening 220 in a closed-loop manner. The thickness of the elastic gasket 260 in the stacking direction is slightly larger than the depth of the surrounding groove 240. Therefore, before the insulation member 202 and the support member 204 abut against each other, the elastic gasket 260 in the surrounding groove 240 slightly protrudes from the surface of the insulation member 202.

Each of the end structures 20 further includes a plurality of connecting bolts 268 for connecting the support member 204 and the insulation member 202. The plurality of connecting bolts 268 include inner peripheral bolts 280 and outer peripheral bolts 270. The inner peripheral bolts 280 are passed through the inner insertion holes 212a of the support member 204 and are screwed into the inner holes 230a of the insulation member 202. The outer peripheral bolts 270 are passed through the outer insertion holes 212b of the support member 204 and are screwed into the outer holes 230b of the insulation member 202. The inner peripheral bolts 280 are placed inward of the surrounding groove 240 and the elastic gasket 260 in the widthwise direction. On the contrary, the outer peripheral bolts 270 are placed outward of the surrounding groove 240 and the elastic gasket 260 in the widthwise direction.

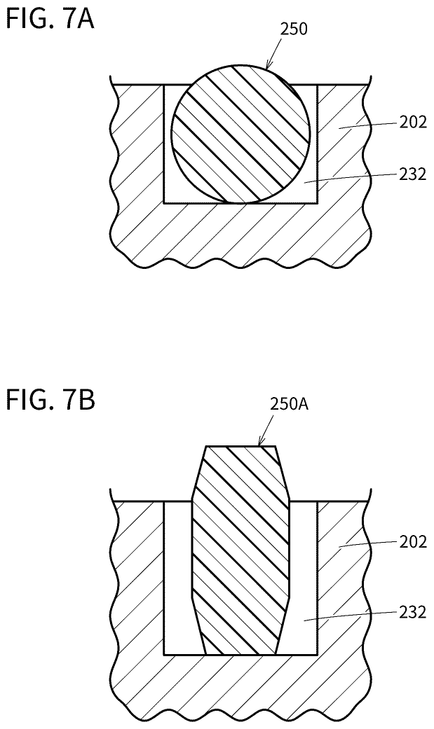

Specific examples of the elastic seal members 250 and the elastic gasket 260 include an O-ring made of rubber or elastomer. As illustrated in FIG. 7A, in the case of an O-ring, the elastic seal members 250 each have a cross section of a substantially perfect circular shape in the diametrical direction. The shape of the cross sections of the elastic seal members 250 and the elastic gasket 260 may be other than a perfect circle shape in the depth direction of the accommodation grooves 232. Examples of the shape other than the perfect circular shape include an elliptical shape, a substantially barrel shape shown in FIG. 7B, and the like. FIG. 7B illustrates an example of the elastic seal member 250A in which the shape of the cross section in the depth direction of the accommodation groove 232 is substantially barrel shape.

In the above configuration, three or more of the plurality of connecting bolts 268 are arranged around each of the plurality of flow passages 22 (see FIGS. 3 and 4). Note that some of the connecting bolts 268 around one flow passage 22 may also serve as the connecting bolts 268 around another flow passage 22. This point will be described with reference to FIGS. 3 and 4.

As shown in FIG. 3, the reference numerals of the outer peripheral bolts 270 located closer to the third side 11c are 271a, 271b, 271c, 271d, 271e, and 271f. The reference signs of the inner peripheral bolts 280 located closer to the third side 11c are 281a, 281b, 281c, and 281d. The first oxygen-containing gas discharge passage 26b is surrounded by the outer peripheral bolt 271a, the outer peripheral bolt 271b, the outer peripheral bolt 271c, and the inner peripheral bolt 281a. The first coolant discharge passage 28c is surrounded by the outer peripheral bolt 271c, the outer peripheral bolt 271d, the inner peripheral bolt 281a, and the inner peripheral bolt 281b.

The fuel gas supply passage 24a is surrounded by the outer peripheral bolt 271d, the inner peripheral bolt 281b, and the inner peripheral bolt 281c. The second coolant discharge passage 28d is surrounded by the outer peripheral bolt 271d, the outer peripheral bolt 271e, the inner peripheral bolt 281c, and the inner peripheral bolt 281d. The second oxygen-containing gas discharge passage 26c is surrounded by the outer peripheral bolt 271e, the outer peripheral bolt 271f, and the inner peripheral bolt 281d.

As shown in FIG. 4, the reference numerals of the outer peripheral bolts 270 located closer to the fourth side 11d are 272a, 272b, 272c, 272d, 272e, 272g, and 272f. The reference signs of the inner peripheral bolts 280 located closer to the fourth side 11d are 282a, 282b, 282c, and 282d. The first fuel gas discharge passage 24b is surrounded by the outer peripheral bolt 272a, the outer peripheral bolt 272b, and the inner peripheral bolt 282a. The first coolant supply passage 28a is surrounded by the outer peripheral bolt 272b, the outer peripheral bolt 272c, the inner peripheral bolt 282a, and the inner peripheral bolt 282b.

The oxygen-containing gas supply passage 26a is surrounded by the outer peripheral bolt 272c, the outer peripheral bolt 272d, the inner peripheral bolt 282b, and the inner peripheral bolt 282c. The second coolant supply passage 28b is surrounded by the outer peripheral bolt 272d, the outer peripheral bolt 272e, the inner peripheral bolt 282c, and the inner peripheral bolt 282d. The second fuel gas discharge passage 24c is surrounded by the outer peripheral bolt 272e, the outer peripheral bolt 272f, the outer peripheral bolt 272g, and the inner peripheral bolt 282d.

The above combination is one example. Other combinations may be used as long as each of the plurality of flow passages 22 is surrounded by three or more connecting bolts 268.

The outer peripheral bolts 270 include an outer peripheral bolt 273a and an outer peripheral bolt 273b arranged closer to the first side 11a, and further include an outer peripheral bolt 274a and an outer peripheral bolt 274b arranged closer to the second side 11b. The outer peripheral bolt 273a, the outer peripheral bolt 273b, the outer peripheral bolt 274a, and the outer peripheral bolt 274b are located in the vicinity of the outer periphery of the elastic gasket 260.

A method of assembling the fuel cell stack 10 configured as described above will be described.

As shown in FIG. 1, an operator stacks the plurality of unit cells 12. Thus, the cell stack body 14 is obtained. Next, the operator provides the end structures 20 at both ends of the cell stack body 14. For this purpose, the operator puts the first seal body 250a in the first groove 232a (see FIGS. 2 and 3) formed in the insulation member 202. If the first annular portion 252a to the fifth annular portion 252e are separate members from each other, it is necessary to perform work of putting the first annular portion 252a to the fifth annular portion 252e in the first annular groove portion 233a to the fifth annular groove portion 233e, respectively. In this case, the operation is cumbersome.

In contrast, in the present embodiment, the first seal body 250a is a single member in which the plurality of annular portions 252 are integrated via the plurality of connecting portions 254. Therefore, by roughly positioning the first seal body 250a in the first groove 232a, and then pushing the first annular portion 252a to the fifth annular portion 252e into the first annular groove portion 233a to the fifth annular groove portion 233e, respectively, the first seal body 250a can be accommodated in the first groove 232a. The same applies to the second seal body 250b. Therefore, the operation is simplified. Further, the work efficiency in assembling the fuel cell stack 10 is improved.

The operator also puts the elastic gasket 260 in the surrounding groove 240. In this manner, the elastic seal members 250 (the first seal body 250a and the second seal body 250b) and the elastic gasket 260 are mounted on the insulation member 202. At this time, as shown in FIG. 5, the annular portions 252 of the elastic seal members 250 in the accommodation grooves 232 protrude inward from the insulation member 202 in the stacking direction. Similarly, a part of the elastic gasket 260 in the surrounding groove 240 protrudes inward in the stacking direction. Each connecting portion 254 of the elastic seal members 250 placed in the accommodation grooves 232 may or may not protrude from the surface of the insulation member 202; preferably, it does not protrude.

Next, the operator connects the support member 204 and the insulation member 202 to each other. That is, as shown in FIG. 2, the end surface of the insulation member 202 to which the two elastic seal members 250 and the elastic gasket 260 are attached is made to face the support member 204. In this state, the plurality of connecting bolts 268 are inserted into the bolt holes 230 via the bolt insertion holes 212, respectively. Further, the plurality of connecting bolts 268 are rotated and screwed into the bolt holes 230, respectively.

With this screwing operation, the end surface of the support member 204 is brought into close contact with (abuts against) the end surface of the insulation member 202. Therefore, the protruded portions of the elastic seal members 250 in the accommodation grooves 232 are pushed. Similarly, the protruded portion of the elastic gasket 260 in the surrounding groove 240 is pushed. That is, the elastic seal members 250 is accommodated in the accommodation grooves 232 in a state where at least the respective annular portions 252 are compressed, and the elastic gasket 260 is accommodated in the surrounding groove 240 in a compressed state. In this manner, an assembly of the support member 204, the current collecting member 224 inserted into the opening 206 of the support member 204, and the insulation member 202 is obtained.

In the case where the connecting portions 254 of the elastic seal members 250 placed in the accommodation grooves 232 do not include any protruded portion, the connecting portions 254 can be prevented from receiving a large load during the above-described screwing operation. In other words, the connection portions 254 can be prevented from being broken by the screwing operation of the plurality of connecting bolts 268.

Next, the operator stacks the end plates 200 on the ends of the cell stack body 14 with the assemblies interposed therebetween. The support members 204 in the assemblies face the cell stack body 14, and the insulation members 202 in the assemblies face the end plates 200. After the end structures 20 are provided at opposite ends of the cell stack body 14 in the stacking direction as described above, the operator fastens the pair of end plates 200 to each other with coupling bars 40 or the like. As a result, the unit cells 12 are brought into close contact with each other, and the cell stack body 14 and the end structures 20 are brought into close contact with each other.

Next, a method of operating the fuel cell stack 10 will be described.

When the fuel cell stack 10 is operated, fuel gas such as hydrogen gas is supplied to the fuel gas supply passage 24a shown in FIG. 1, and oxygen-containing gas such as compressed air is supplied to the oxygen-containing gas supply passage 26a. The fuel gas flowing through the fuel gas flow field of each unit cell 12 contacts the anode. The oxygen-containing gas flowing through the oxygen-containing gas flow field of each unit cell 12 contacts the cathode. As a result, each of the unit cells 12 generates power. The obtained electric power is supplied to an external load via the current collecting members 224 and the terminal plates 222 shown in FIG. 2. The unreacted fuel gas is discharged from the first fuel gas discharge passage 24b and the second fuel gas discharge passage 24c, and the unreacted oxygen-containing gas is discharged from the first oxygen-containing gas discharge passage 26b and the second oxygen-containing gas discharge passage 26c.

Each of the unit cells 12 is heated by power generation. Heat is absorbed by the coolant supplied to the first coolant supply passage 28a and the second coolant supply passage 28b. After flowing through the coolant flow field of each unit cell 12, the coolant is discharged from the first coolant discharge passage 28c and the second coolant discharge passage 28d.

While the fuel cell stack 10 is operated, the plurality of annular portions 252 (see FIG. 3) of the elastic seal members 250 seal between the insulation member 202 and the support member 204 around the plurality of flow passages 22 at each of the end structures 20. This prevents the fuel gas from leaking out of the fuel gas flow passages. Similarly, the oxygen-containing gas is prevented from leaking out of the oxygen-containing gas flow passages, and the coolant is prevented from leaking out of the coolant flow passages.

At each of the end structures 20, the elastic gasket 260 seals between the insulation member 202 and the support member 204 at the outer periphery of the terminal plate 222 and the current collecting member 224. This prevents the terminal plate 222 and the current collecting member 224 from being in contact with the fuel gas, the oxygen-containing gas and the coolant. Therefore, the terminal plate 222 and the current collecting member 224 are prevented from corroding.

Each unit cell 12 causes thermal expansion as it is heated. Here, with respect to each of the elastic seal members 250, three or more connecting bolts 268 are disposed around each of the first annular portion 252a to the fifth annular portion 252e. Therefore, the first annular portion 252a to the fifth annular portion 252e receive a large fastening force from the connecting bolts 268. Thus, the first annular portion 252a to the fifth annular portion 252e respectively in the first annular groove portion 233a to the fifth annular groove portion 233e maintain a compressed state (contracted state). That is, the first annular portion 252a to the fifth annular portion 252e between the support member 204 and the insulation member 202 are prevented from returning (expanding) to the original shape after compression due to the elastic restoring force.

This prevents a gap from being formed between the support member 204 and the insulation member 202 due to the first annular portion 252a to the fifth annular portion 252e returning to the original shape after compression. As a result, the sealing performance between the support member 204 and the insulation member 202 is prevented from being lowered.

In the case where the thickness T2 of the first connecting portion 254a to the fourth connecting portion 254d is smaller than the depth D of the first straight groove portion 234a to the fourth straight groove portion 234d, the first connecting portion 254a to the fourth connecting portion 254d are not compressed in a state where the connecting bolts 268 are fastened. Therefore, the support member 204 and the insulation member 202 are prevented from being pressed by the elastic restoring forces of the first connecting portion 254a to the fourth connecting portion 254d. Thus, it is possible to avoid a decrease in the sealing performance between the support member 204 and the insulation member 202 by being pressed by the first connecting portion 254a to the fourth connecting portion 254d.

As described above, even when the elastic seal members 250 that are elastic solids reused, a gap is prevented from being formed between the support member 204 and the insulating portion by the reaction force from the elastic seal members 250. Therefore, even when the unit cells 12 (or the cell stack body 14) thermally expand, the sealing performance between the support member 204 and the insulation member 202 is prevented from being lowered.

In addition, the elastic gasket 260 receives a large fastening force from the inner peripheral bolts 281a to 281d, the inner peripheral bolts 282a to 282d, and the outer peripheral bolts 273a, 273b, 274a, and 274b. Therefore, the elastic gasket 260 is kept in a compressed state (contracted state) in the surrounding groove 240. That is, the elastic gasket 260 is prevented from returning (expanding) to the original shape after compression based on the elastic restoring force between the support member 204 and the insulation member 202. Thus, it is possible to avoid the formation of a gap between the support member 204 and the insulation member 202 due to the elastic gasket 260 returning to its original shape. As a result, the sealing performance between the support member 204 and the insulation member 202 is prevented from being lowered.

According to the present embodiment, the following effects are obtained.

As shown in FIG. 2, each of the end structures 20 of the fuel cell stack 10 includes the insulation member 202 and the support member 204. The insulation member 202 includes accommodation grooves 232, and the elastic seal members 250 are received in the accommodation grooves 232. The support member 204 and the insulation member 202 are connected to each other by a plurality of connecting bolts 268. The support member 204 and the insulation member 202 have the plurality of flow passages 22. The elastic seal members 250 includes a plurality of annular portions 252 (first annular portion 252a to fifth annular portion 252e) surrounding the plurality of flow passages 22, respectively. As shown in FIG. 3, in the above configuration, three or more of the plurality of connecting bolts 268 are disposed around each of the plurality of flow passages 22.

Since three or more connecting bolts 268 are disposed around each of the flow passages 22, the plurality of annular portions 252 of the elastic seal members 250 receive a large fastening force from the connecting bolts 268. Therefore, the elastic seal members 250 are kept in a compressed state in the accommodation grooves 232. Therefore, for example, when the fuel cell stack 10 thermally expands due to operation, the plurality of annular portions 252 between the support member 204 and the insulation member 202 are prevented from expanding due to elastic restoring forces.

This prevents a gap from being formed between the support member 204 and the insulation member 202. As a result, the sealing performance between the support member 204 and the insulation member 202 is prevented from being lowered.

The support member 204 has the opening 206 that extends through the support member 204 along the stacking direction. Each of the end structures 20 includes the closed-loop elastic gasket 260 located between the insulation member 202 and the support member 204 and surrounding the opening 206.

The closed-loop elastic solid gasket 260 is placed around the opening 206 to prevent the reactant gases or the coolant from flowing toward the opening 206. Therefore, the reactant gases or the coolant is prevented from coming into contact with the current collecting member 224 disposed in the opening 206.

The plurality of connecting bolts 268 include inner peripheral bolts 280 disposed on an inner periphery (opening 206 side) of the support member 204 and outer peripheral bolts 270 disposed on an outer periphery (outer peripheral side) of the support member 204. Each of the plurality of flow passages 22 is located between the inner peripheral bolts 280 and the outer peripheral bolts 270.

In this case, the fastening forces by the inner peripheral bolts 280 and the fastening forces by the outer peripheral bolts 270 are balanced. Therefore, local expansion of the annular portions 252 due to an imbalance of the fastening forces is prevented. It is preferable that the inner peripheral bolts 280 are arranged inward of the elastic gasket 260. In this manner, the fastening forces of the inner peripheral bolts 280 and the fastening forces of the outer peripheral bolts 270 are applied to the elastic gasket 260, and thus the elastic gasket 260 is also kept in the compressed state. In other words, the elastic gasket 260 is prevented from expanding.

Some or one of the plurality of (three or more) connecting bolts 268 arranged around one flow passage 22 also serves as the plurality of (three or more) connecting bolts 268 around another flow passage 22 adjacent to the one flow passage 22.

In this manner, it is possible to reduce the number of the connecting bolts 268. Therefore, the time required for the fastening operation of the connecting bolts 268 is shortened. In addition, the weight of the fuel cell stack 10 can be reduced.

The elastic seal members 250 includes a plurality of connecting portions 254 (first connecting portion 254a to fourth connecting portion 254d) that connect two adjacent ones of the plurality of annular portions 252.

According to this configuration, the seal member can be disposed around the plurality of flow passages 22 by one attachment operation. Therefore, the efficiency of the assembly work of the fuel cell stack 10 is improved.

As shown in FIG. 5, the thickness T2 of each of the plurality of connecting portions 254 along the stacking direction is smaller than the thickness T1 of each of the plurality of annular portions 252 along the stacking direction.

In this case, even when the plurality of connection portions 254 expand due to the elastic restoring forces, the reaction forces received by the insulation member 202 and the support member 204 from the plurality of connection portions 254 is small. Therefore, the sealing performance between the insulation member 202 and the support member 204 is less affected.

In the aspect shown in FIG. 5, the thickness T2 of each of the plurality of connecting portions 254 is smaller than the depth D of the accommodation groove 232.

In this case, the plurality of connection portions 254 does not protrude from the accommodation groove 232. Therefore, for example, when the connecting bolts 268 are fastened, a large load is prevented from acting on the connection portions 254, and the connection portions 254 are prevented from being broken.

The insulation member 202 is made of resin, and the accommodation grooves 232 are formed in the insulation member 202.

The insulation member 202 is produced by, for example, injection molding using a molten resin. When the insulation member 202 is molded by injection molding, the accommodation grooves 232 can be easily molded.

In relation to the above-described embodiment, the following supplementary notes are further disclosed.

### Supplementary Note 1

The fuel cell stack (10) of the present disclosure includes the cell stack body (14) in which the plurality of unit cells (12) are stacked, and the end structures (20) provided at opposite ends of the cell stack body in a stacking direction, wherein each of the end structures includes: the end plate (200) disposed at an outermost position in the stacking direction; the insulation member (202) arranged between the cell stack body and the end plate in the stacking direction; the support member (204) interposed between the cell stack body and the insulation member in the stacking direction; the accommodation groove (232) formed in the support member or the insulation member; the elastic seal member (250) accommodated in the accommodation groove and configured to seal between the support member and the insulation member; and the plurality of connection bolts (268) configured to connect the support member and the insulation member, the support member includes the plurality of flow passages (22) each extending along the stacking direction and allowing a fuel gas, an oxygen-containing gas, or a coolant provided for the cell stack body to flow therethrough, the elastic seal member surrounds outer peripheries of the plurality of flow passages, and three or more of the plurality of connection bolts are arranged around each of the plurality of flow passages.

Since three or more connecting bolts are disposed around each of the flow passages, the elastic seal member receives a large fastening force from the connecting bolts. Therefore, the elastic seal member is prevented from returning (expanding) to its original shape by its elastic restoring force. Therefore, a gap between the support member and the insulation member can be avoided from being formed, and therefore, the sealing performance between the support member and the insulation member can be prevented from deteriorating.

### Supplementary Note 2

In the fuel cell stack according to the Supplementary Note 1, the support member may have the opening (206) that extends through the support member along the stacking direction, and each of the end structures may have the elastic gasket (260) arranged between the insulation member and the support member and having a loop shape surrounding an entire perimeter of the opening.

Since the loop-shaped elastic gasket is arranged around the entire perimeter of the opening, the reactant gases or the coolant is prevented from flowing toward the opening. Therefore, for example, when the current collecting member is disposed in the opening, the reactant gases or the coolant is prevented from coming into contact with the current collecting member.

### Supplementary Note 3

In the fuel cell stack according to the Supplementary Note 2, the plurality of connecting bolts may include thinner peripheral bolt (280) disposed at thinner periphery of the support member and the outer peripheral bolt (270) disposed at the outer periphery of the support member, and each of the plurality of flow passages may be located between the inner peripheral bolt and the outer peripheral bolt.

In this case, the fastening force by the inner peripheral bolt and the fastening force by the outer peripheral bolt are balanced. Therefore, local expansion of the elastic seal member due to an imbalance of the fastening forces is prevented.

### Supplementary Note 4

In the fuel cell stack according to any one of Supplementary Notes 1 to 3, a part of the three or more connecting bolts around one of the plurality of flow passages may also serve as the three or more connecting bolts around another one of the flow passages adjacent to the one of the flow passages.

This reduces the number of connecting bolts. Therefore, the time required for the fastening operation of the connecting bolts is shortened. In addition, the weight of the fuel cell stack can be reduced.

### Supplementary Note 5

In the fuel cell stack according to any one of Supplementary Notes 1 to 4, the elastic seal member may include the plurality of annular portions (252) surrounding the plurality of flow passages, respectively, and the plurality of connection portions (254) connecting two adjacent annular portions among the plurality of annular portions.

According to this configuration, the seal members can be arranged around the plurality of flow passages by one mounting operation. Therefore, the efficiency of the assembly work of the fuel cell stack is improved.

### Supplementary Note 6

In the fuel cell stack according to Supplementary Note 5, each of the plurality of connecting portions in an uncompressed state may have the thickness (T2) along the stacking direction smaller than the thickness (T1) of each of the plurality of annular portions in an uncompressed state along the stacking direction.

In this case, even when the plurality of connection portions expand due to elastic restoring forces, the sealing performance between the insulation member and the support member is less affected.

### Supplementary Note 7

In the fuel cell stack according to Supplementary Note 6, each of the plurality of connection portions in an uncompressed state may have the thickness smaller than the depth (D) of the accommodation grooves.

According to this configuration, the connection portions are prevented from protruding from the accommodation groove even in the uncompressed state. Therefore, for example, when the connecting bolts are fastened, a large load is prevented from acting on the connection portions, and the connection portions are prevented from being broken.

### Supplementary Note 8

In the fuel cell stack according to any one of Supplementary Notes 1 to 7, the insulation member may be made of resin, and the accommodation groove may be formed in the insulation member.

In this case, the accommodation groove can be easily formed when the insulation member is being formed from a molten resin.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A fuel cell stack comprising a cell stack body in which a plurality of unit cells are stacked, and end structures provided at opposite ends of the cell stack body in a stacking direction, wherein
each of the end structures includes:
an end plate disposed at an outermost position in the stacking direction;
an insulation member arranged between the cell stack body and the end plate in the stacking direction;
a support member interposed between the cell stack body and the insulation member in the stacking direction;
an accommodation groove formed in the support member or the insulation member;
an elastic seal member accommodated in the accommodation groove and configured to seal between the support member and the insulation member; and
a plurality of connection bolts configured to connect the support member and the insulation member,
the support member includes a plurality of flow passages each extending along the stacking direction and allowing a fuel gas, an oxygen-containing gas, or a coolant provided for the cell stack body to flow therethrough, and
the elastic seal member surrounds outer peripheries of the plurality of flow passages, and three or more of the plurality of connection bolts are arranged around each of the plurality of flow passages.

2. The fuel cell stack according to claim 1, wherein the support member includes an opening that extends through the support member along the stacking direction, and
each of the end structures has an elastic gasket arranged between the insulation member and the support member and having a loop shape surrounding an entire perimeter of the opening.

3. The fuel cell stack according to the claim 2, wherein the plurality of connecting bolts include an inner peripheral bolt disposed at an inner periphery of the support member and an outer peripheral bolt disposed at an outer periphery of the support member, and each of the plurality of flow passages is located between the inner peripheral bolt and the outer peripheral bolt.

4. The fuel cell stack according to claim 1, wherein a part of the three or more connecting bolts surrounding the outer periphery of one of the plurality of flow passages may also serve as the three or more connecting bolts surrounding the outer periphery of another one of the flow passages adjacent to the one of the flow passages.

5. The fuel cell stack according claim 1, wherein the elastic seal member may include a plurality of annular portions surrounding the plurality of flow passages, respectively, and a plurality of connection portions connecting two adjacent annular portions among the plurality of annular portions.

6. The fuel cell stack according to claim 5, wherein each of the plurality of connecting portions in an uncompressed state has a thickness along the stacking direction smaller than a thickness of each of the plurality of annular portions in an uncompressed state along the stacking direction.

7. The fuel cell stack according to claim 6, wherein each of the plurality of connection portions in the uncompressed state has the thickness smaller than a depth of the accommodation grooves.

8. The fuel cell stack according to claim 1, wherein the insulation member is made of resin, and the accommodation groove is formed in the insulation member.
